(19) United States
(12) Patent Application Publication
(10) Pub. No.: US 2026/0343226 A1
(43) Pub. Date: Oct. 29, 2026

(54) SEAMLESS COMMUNICATION SESSION CONTINUITY DURING ACCESS POINT TRANSITION

(71) Applicant: Charter Communications Operating, LLC, St. Louis, MO (US)

(72) Inventor: Timothy Clark Bleidorn-Piper, Colorado Springs, CO (US)

(21) Appl. No.: 19/191,787

(22) Filed: Apr. 28, 2025

(51) Int. Cl. H04W 12/069; H04L 12/46; H04W 12/088; H04W 76/10

(52) U.S. Cl. CPC H04W 12/069; H04L 12/4633; H04W 12/088; H04W 76/10

(57) ABSTRACT

A network access request for a first computing device is received via a first Access Point (AP) including a pre-shared key that associates the first computing device with a virtual Customer Premises Equipment (vCPE) executing on a computing system. Based on the pre-shared key, an external Internet Protocol (IP) address is assigned to the first computing device with a gateway virtual Network Function (vNF) of the vCPE. Responsive to a communication session request addressed to the external IP address, a live communication session is established between the first computing device and a second computing device via the first AP. A second network access request comprising the pre-shared key is received for the first computing device via a second AP. Based on the pre-shared key, the live communication session between the first and the second computing devices is maintained via the second AP.

### BACKGROUND

Wi-Fi is a wireless networking technology that allows electronic devices to exchange data or connect to the internet using radio waves, typically within the 2.4 GHz and 5 GHz frequency bands. Devices capable of Wi-Fi communication can connect to a local area network (LAN) through an access point (e.g., a wireless router, etc.), which manages data traffic between the connected devices and the internet. Conventionally, wireless routers have served as the central hub for wireless communication, enabling devices within their range to send and receive data packets wirelessly. In addition to traditional data exchange, Wi-Fi networks may also support voice communication protocols that enable users to initiate and receive voice calls over the internet, a process commonly known as Wi-Fi calling. This functionality typically relies on Voice over Internet Protocol (VoIP) technologies and requires compatibility between the calling device, the network infrastructure, and the service provider.

### SUMMARY

Maintenance of communication sessions during access point transitions is proposed herein. More specifically, a computing system can receive a network access request for a computing device via a first access point (AP) device, such as a router. The network access request can include a pre-shared key that identifies a virtual Customer Premises Equipment (vCPE). The computing system can use the vCPE to maintain a fixed address for the computing device, therefore ensuring that communication sessions are not dropped when the user transitions between access points.

In one implementation, a method is provided. The method includes receiving, by a computing system comprising one or more processor devices, a network access request for a first computing device via a first Access Point (AP), the network access request comprising a pre-shared key that associates the first computing device with a virtual Customer Premises Equipment (vCPE) executing on the computing system. The method further includes based on the pre-shared key, assigning, by the vCPE, an external Internet Protocol (IP) address to the first computing device with a gateway virtual Network Function (vNF) of the vCPE. The method further includes responsive to a communication session request addressed to the external IP address, establishing, by the vCPE, a live communication session between the first computing device and a second computing device via the first AP. The method further includes receiving, by the vCPE, a second network access request for the first computing device via a second AP located at a different location than the first AP, the second network access request comprising the pre-shared key. The method further includes based on the pre-shared key, maintaining, by the vCPE, the live communication session between the first computing device and the second computing device via the second AP.

In another implementation, a computing system is provided. The computing system includes a memory, and one or more processor device(s) coupled to the memory. The processor device(s) are to receive a network access request for a first computing device via a first AP device, the network access request comprising a pre-shared key that associates the first computing device with a vCPE executing on the computing system. The processor device(s) are further to, based on the pre-shared key, assign an external IP address to the first computing device with a gateway virtual Network Function vNF of the vCPE. The processor device(s) are further to, responsive to a communication session request addressed to the external IP address, establish a live communication session between the first computing device and a second computing device via the first AP. The processor device(s) are further to receive a second network access request for the first computing device via a second AP located at a different location than the first AP, the second network access request comprising the pre-shared key. The processor device(s) are further to, based on the pre-shared key, maintain the live communication session between the first computing device and the second computing device via the second AP.

In another implementation, a non-transitory computer-readable storage medium is provided. The non-transitory computer-readable storage medium includes executable instructions to cause a processor device executing a vCPE to receive a network access request for a first computing device via a first AP device, the network access request comprising a pre-shared key that associates the first computing device with the vCPE. The instructions further cause the processor device to, based on the pre-shared key, assign an external Internet Protocol (IP) address to the first computing device with a gateway vNF of the vCPE. The instructions further cause the processor device to responsive to a communication session request addressed to the external IP address, establish a live communication session between the first computing device and a second computing device via the first AP. The instructions further cause the processor device to receive a second network access request for the first computing device via a second AP located at a different location than the first AP, the second network access request comprising the pre-shared key. The instructions further cause the processor device to, based on the pre-shared key, maintain the live communication session between the first computing device and the second computing device via the second AP.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1A is a block diagram of a computing environment suitable for implementing seamless communication session continuity during access point migration at a first time T1 according to some implementations of the present disclosure.

FIG. 1B illustrates the computing environment of FIG. 1A at a second time T2 subsequent to the first time T1 according to some implementations of the present disclosure.

FIG. 1C illustrates the computing environment of FIG. 1A at a third time T3 according to some implementations of the present disclosure.

FIG. 2 depicts a flow chart diagram of an example method for according to some implementations of the present disclosure.

FIG. 3 is a block diagram of the computing system suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Wireless access points (e.g., routers, etc.) are now featured in many homes across the United States. In Multi-Dwelling Units (MDUs) (e.g., apartments, townhomes, condominiums, etc.), it is not uncommon for each MDU in a building to feature its own wireless access point. For example, many MDUs will include a wireless access point that serves as both a wireless router and modem. This dual modem/router is usually provided by the internet service provider for internet services to the MDU.

In such instances, access to a user's home wireless access point is typically limited to within a few meters of the user's home. If a user leaves their home to go to the lobby of the building, the user must reconnect their device to a different wireless access point in the lobby once they leave the range of their home wireless access point. In recent years, new wireless technologies such as mesh networks have partially solved this problem. Mesh networks function by “boosting” or “extending” the signals output (and received) by a wireless access point. A signal sent from a user device to a mesh booster will be forwarded (i.e., “daisy-chained”) to the access point via any other mesh boosters in between the access point and the receiving mesh booster.

Because mesh extenders (also known as “dumb” access points) only extend the same signal transmitted by the wireless access point, mesh extenders do not include many of the network functions typically included in conventional wireless access points. For example, a mesh extender device will typically not include a gateway function for Internet Protocol (IP) routing, Network Address Translation (NAT), etc. One service provided by the gateway function of a wireless access point is assigning and maintaining an IP address (or port) for devices while connected to the access point. With a mesh network, a device can maintain the same internal IP address as the device traverses between different mesh extender devices.

When using mesh extenders to boost the wireless signal of a wireless access point, the boosted signal generally grows weaker as the signal is extended further from the access point. As such, once a wireless signal has been extended a certain distance from a wireless access point, another wireless access point is generally used so that a new signal can be extended. Conventional wireless access technologies have been developed so that a user can be handed off from one wireless access point to another without having to enter a password or user credentials. However, wireless access points each have their own unique addressing information for devices served by the wireless access point. As such, when a user device migrates from one wireless access point to another, the user device's IP stack will be recreated by the new wireless access point by assigning the user device new internal and external IP addresses.

If the user device is being used to view a website, the user device's IP stack being recreated is unlikely to be perceptible to the user, or at the very least, is unlikely to disrupt the user's experience. Conversely, if the user is participating in a Wifi call, it is likely that recreating the user's IP stack will cause the Wifi call to drop. Similarly, recreating the IP stack can also cause disruptions to streaming media content, playing online video games, media conferences, etc. As such, an approach to maintain continuity for live communications while migrating between wireless access points is desired.

Accordingly, implementations described herein propose maintaining continuous communication sessions during access point migration. More specifically, a computing system can receive a network access request for a computing device via a first access point (AP) device, such as a router. The network access request can include a pre-shared key. The pre-shared key can identify the computing device. For example, the computing system may be a system associated with a network service provider (e.g., an internet service provider), and the computing device may be a user device of a user associated with the pre-shared key that subscribes to internet services provided by the network service provider.

In particular, the pre-shared key can associate the computing device with a virtual Customer Premises Equipment (vCPE) executing on the computing system. As described herein, a vCPE can refer to a virtualized device, or set of instructions (e.g., functions, network functions, etc.) that perform operations typically performed by a CPE. A CPE refers to a device that facilitates access to internet services, such as a router, modem, hybrid router/modem, etc. More specifically, the vCPE can be a virtualized device, such as a virtualized router, that is instantiated for the user.

The vCPE can include (or otherwise implement) network functions typically handled by a physical CPE. More specifically, the vCPE can implement a variety of layer 3 functions, such as forwarding and lookup, in addition to packet-flow/per-device level policy application. The vCPE can provide IPv4 and IPv6 addressing via Dynamic Host Configuration Protocol (DHCP) or Stateless Address Autoconfiguration (SLAAC) mechanisms. The vCPE can maintain a layer 2 adjacency with the access points used by the computing device to connect to the network. As such, the vCPE can replace physical CPEs for implementing the layer 3 gateway, firewall, NAT point, etc. Meanwhile, physical CPEs can be modified with functions that facilitate layer 2 communication between the computing device and the vCPE for the user. To do so, the physical CPE can include physical LAN interfaces, which can be bridged alongside the private SSID to the vCPE via a layer 2 logical link and encapsulated for transport over layer 3 domain to the vCPE.

By virtualizing these layer 3 functions that are typically implemented by a physical router device located in a user's home, the vCPE can extend the private address space into the wider network (although obfuscated and decoupled for security purposes). This extension of the private host address space into the network has the effect of allowing highly efficient application of the Carrier-grade NAT (CGN) function while supporting the re-use of RFC 1918 address space (e.g., conventional IP address space) for private LAN addressing at scale.

For example, the vCPE can include a virtual gateway function. The virtual gateway function can assign an address to the computing device in the same manner as would the gateway function or Dynamic Host Configuration Protocol (DHCP) service of a physical router device. Because the vCPE is virtualized and executed in a cloud environment, the functions provided by the vCPE are not tied to a specific physical device. This means that a device served by a vCPE does not need to recreate its IP stack when connecting to a new access point because the IP addresses of the device are maintained by the vCPE rather than the new access point. Further, because the network management functionality typically provided by physical CPE devices (e.g., routers, etc.) is handled by the vCPE, the physical CPE devices can instead act in the same manner as the “dumb” mesh extenders by “extending” a wireless signal that is managed at the vCPE.

As such, the vCPE can assign and maintain an IP address for a connected device regardless of the access point used by the connected device. In other words, unlike physical access points, the vCPE can maintain an internal IP address for a computing device as the computing device migrates across access points, therefore maintaining any live communication sessions active on the computing device. This also enables Local Area Network (LAN) functionality from any location, as the vCPE can provide virtualized LAN network functionality.

Specifically, based on the network access request, the computing system can identify a vCPE associated with the user. For example, the computing system may include a separate vCPE for each subscriber of an internet service, and may instantiate or execute the vCPE in response to the network access request. Alternatively, the computing system may keep an instance of the vCPE associated with the user of the computing device running (e.g., to provide LAN functionality), and may identify that instance based on the pre-shared key.

Once identified, the vCPE can assign an IP address (e.g., an internal IP address, external IP address or port, etc.) to the computing device with a gateway virtual Network Function (vNF) of the vCPE. The network access request received by the computing system can be received via a first Access Point (AP). For example, the first AP may be a mesh network extender, or a wireless router operating in a manner similar to a mesh network extender.

The vCPE can receive a communication session request addressed to the IP address of the computing device from a second computing device. In response, the vCPE can establish a communication session between the first computing device and the second computing device via the first AP. For example, the vCPE may send session establishment information to the first AP, and the first AP can forward the session establishment information to the computing device.

The vCPE can receive a second network access request for the first computing device via a second AP located at a different location than the first AP. For example, assume that the first computing device is a user device (e.g., a smartphone, laptop, etc.) for a student living in a dormitory where the first access point is located. The user may start a Wifi calling session with another user while standing in the user's dormitory via the first access point. The user may then begin to exit the dormitory on foot. As the user traverses, they may leave the area served by the first access point and enter an area served by the second access point. As the computing device transitions to being served by the second access point, the computing device can send the second network access request to the vCPE.

Upon receipt of the second network access request, the vCPE can maintain the live communication session established on the first computing device. For example, the vCPE can maintain the IP address(es) assigned to the first computing device as the computing device transitions between access points. In turn, by maintaining the IP address(es) assigned to the first computing device, the vCPE can ensure that traffic addressed to the first computing device is properly delivered and the communication session is maintained (e.g., via the layer 2 link between the vCPE and the second access point).

Aspects of the present disclosure provide a number of technical effects and benefits. As one example technical effect and benefit, current implementations of wireless access points do not enable computing devices to transition between wireless access points without recreating the computing device's IP stack. In turn, this causes communication sessions to “drop” or disconnect whenever a user's movement causes the user's computing device to transition from one access point to another. However, implementations described herein maintain a live communication session across multiple access points, thereby ensuring that live communication sessions are maintained and the user's experience is not disrupted.

As another example technical effect and benefit, it is typically beneficial to perform tasks using wireless networks (e.g., Wifi networks) instead of using high-speed telecommunication networks (e.g., Fifth Generation New Radio (5G NR), etc.), as information is more computationally expensive to transmit using high-speed telecommunications networks (e.g., in terms of compute cycles, bandwidth, power, memory, network resources, etc.). Existing wireless networking technologies do not enable seamless transitions between wireless access points, which often causes live communication sessions to fail during transition. As such, users generally choose to hold live communication sessions using telecommunication networks rather than wireless internet networks. However, implementations described herein enable seamless transitions between access points by maintaining live communication sessions during the transition. In turn, this functionality enables users to use wireless networks to hold live communication sessions, therefore substantially reducing computational resource usage associated with using telecommunications networks.

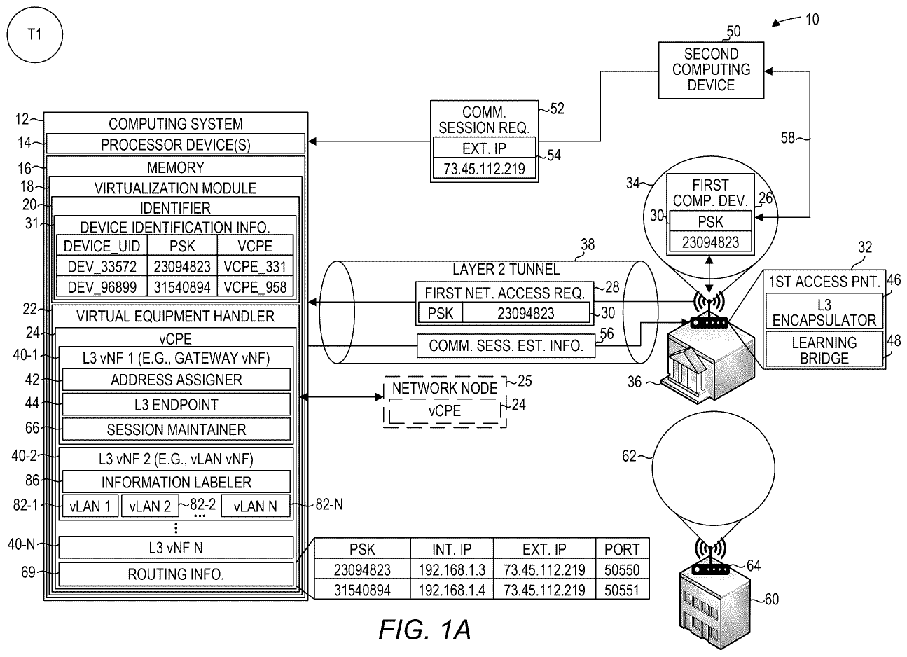

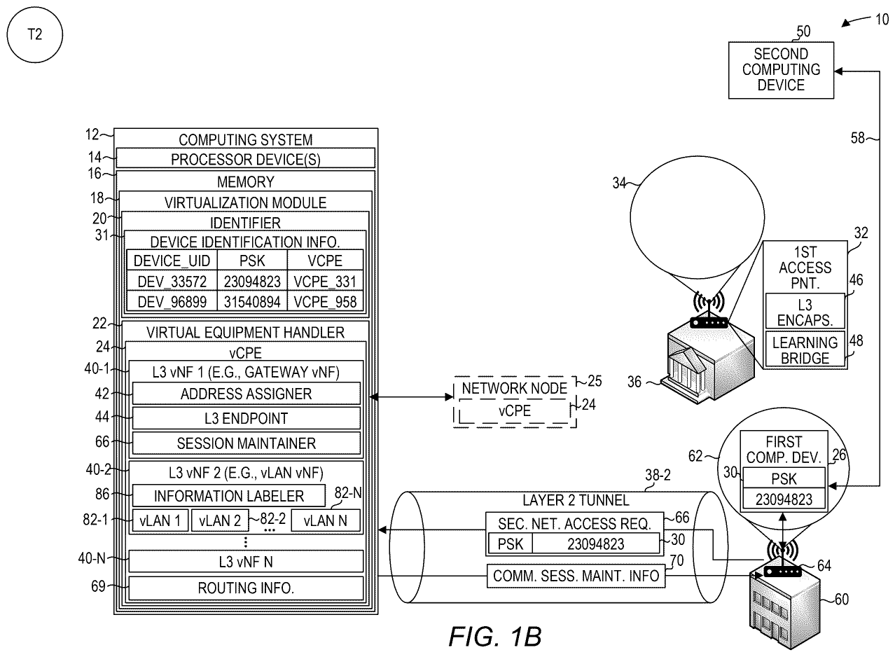

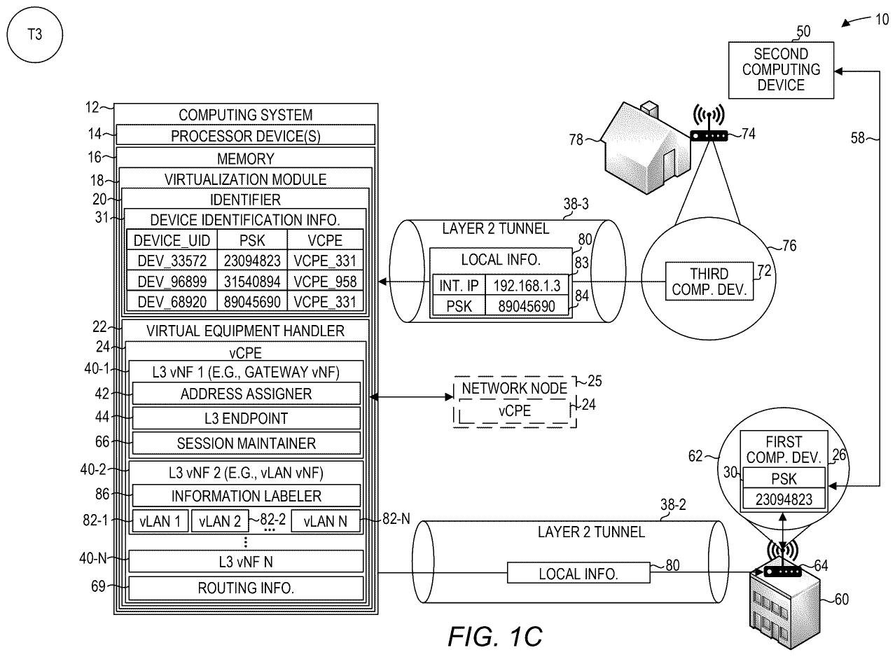

FIG. 1A is a block diagram of a computing environment 10 suitable for implementing seamless communication session continuity during access point migration at a first time T1 according to some implementations of the present disclosure. A computing environment 10 can include a computing system 12 with one or more processor device(s) 14 and a memory 16. As described herein, the “computing environment” 10 can be any type or manner of computing environment (e.g., a collection of computing devices, systems, and related infrastructure associated with a particular entity or organization), such as a “confidential” computing environment in which sensitive data and code is protected during processing, a “public” computing environment, etc.

Specifically, in some implementations, the computing environment 10 can be a computing environment implemented by (or otherwise accessible to) a network service provider, such as an internet service provider, streaming content provider, etc. For example, the computing environment 10 can be a wireless network, wireless network environment, etc. implemented by an internet service provider. As such, in some implementations, the computing system 12 can perform operations to facilitate provision of network services to other device(s) within the computing environment 10. Similarly, in some implementations, the computing system 12 may be one of a plurality of computing devices and/or network devices used to facilitate the provision of network services.

In some implementations, the computing environment 10 can be or otherwise include a confidential computing “enclave” that leverages hardware-based execution environments and secure virtualization technologies, such as memory encryption, to isolate critical computations and prevent unauthorized access to data while in use. Additionally, or alternatively, in some implementations, the computing environment 10 can be a distributed computing environment that utilizes computing resources across a variety of different types of devices (e.g., servers, virtualized devices, user devices, Internet-of-Things (IoT) devices, etc.).

Additionally, or alternatively, in some implementations, the computing environment 10 can be a cloud computing environment implemented using the computing system 12. For example, the computing system 12 can implement a cloud computing platform by implementing a variety of cloud modules to provide cloud functionality. The cloud computing platform implemented by the computing system 12 can be utilized by various users, entities, organizations, devices, etc. within (and/or external to) the computing environment 10.

In some implementations, the computing system 12 may be a computing device that includes multiple computing devices (i.e., a computing system). Alternatively, in some implementations, the computing system 12 may be one or more computing devices within a computing system that includes multiple computing devices. Similarly, the processor device(s) 14 may include any computing or electronic device capable of executing software instructions to implement the functionality described herein.

The memory 16 can be or otherwise include any device(s) capable of storing data, including, but not limited to, volatile memory (random access memory, etc.), non-volatile memory, storage device(s) (e.g., hard drive(s), solid state drive(s), etc.). In some implementations, the memory 16 can include a containerized unit of software instructions (i.e., a “packaged container”). The containerized unit of software instructions can collectively form a container that has been packaged using any type or manner of containerization technique.

A containerized unit of software instructions can include one or more applications, and can further implement any software or hardware necessary for execution of the containerized unit of software instructions within any type or manner of computing environment. For example, the containerized unit of software instructions can include software instructions that contain or otherwise implement all components necessary for process isolation in any environment (e.g., the application, dependencies, configuration files, libraries, relevant binaries, etc.).

In particular, the memory 16 can include one or more storage repositories. As described herein, a “storage repository” refers to either an “on-premises” storage repository (e.g., a repository implemented at one or more physical locations associated with a content service) or a cloud-based storage repository (e.g., a repository implemented via a mix of physical and virtualized resources, generally in a distributed fashion). A cloud-based storage repository can refer to either a first-party cloud storage repository or a third-party cloud storage repository (e.g., a cloud storage repository implemented by a cloud storage provider). As such, in some instances, the physical resources of an on-premises storage repository may implement a first-party cloud storage repository.

In some implementations, the computing environment 10 can include multiple types of nodes. As described herein, a “node” generally refers to a discrete unit of hardware and/or software resources. In some instances, nodes within the computing environment 10 can be configured to perform specific tasks. For example, some nodes within the computing environment 10 can be configured as “compute” or “processing” nodes that handle processing tasks or provide processing-heavy services. Compute nodes are generally allocated with hardware devices that can facilitate processing tasks, such as Graphics Processing Units (GPUs), Central Processing Units (CPUs), Application-specific Integrated Circuits (ASICs), Field-Programmable Gate Arrays (FPGAs), etc.

Conversely, storage nodes can be allocated with hardware devices to facilitate storage tasks, such as storage devices (e.g., hard drives, etc.), memory, high-bandwidth network devices, physical storage media, etc.). It should be noted that in some instances, storage nodes can include processing devices (e.g., CPUs, etc.) to facilitate storage operations (e.g., read/write operations) and processing nodes can include storage devices (e.g., random access memory) to facilitate processing operations.

The memory 16 can include a virtualization module 18. The virtualization module 18 can implement, instantiate, de-instantiate, and otherwise manage network functions to maintain communication session continuity. More specifically, the virtualization module 18 can include an identifier 20. The identifier 20 can identify virtualized devices, such as vCPEs, based on a particular pre-shared key. In particular, the virtualization module 18 can include a virtual equipment handler 22. The virtual equipment handler 22 can instantiate a vCPE 24. In some implementations, the vCPE 24 can be instantiated for a particular user or user computing device (e.g., in response to a network access request, etc.). As such, in some implementations, the vCPE 24 may be one of a plurality of vCPE instances instantiated by the virtual equipment handler 22. When a network connection request is received, the virtualization module 18 can identify which vCPE to associate with the request (or the sender thereof) based on a pre-shared key included in the request.

In some implementations, the virtual equipment handler 22 can store information needed to instantiate a vCPE for a particular user (e.g., a configuration file, a container image, a VM configuration, etc.). For example, a vCPE for a particular user may be stored to a container image and instantiated from the container image for the user as needed. For another example, a vCPE for a particular user may be instantiated by applying a configuration file stored for the user to a vCPE instance selected from a pool of vCPE instances.

In some implementations, the virtualization module 18 may store such information for a plurality of users. For example, if the computing system 12 is associated with an internet service provider, the virtualization module 18 may store vCPE information for each subscriber so that a vCPE can be instantiated for each subscriber. As such, in some instances, the virtualization module 18 may maintain a personalized instance of a vCPE for each subscriber. Alternatively, in some implementations, the virtualization module 18 may maintain a pool of vCPEs for use by subscribers.

In some implementations, the vCPE 24 can be instantiated by the virtual equipment handler 22 and can be executed on the computing system 12 (e.g., using the processor device(s) 14 and the memory 16, etc.). Alternatively, in some implementations, the vCPE 24 can be instantiated on a network node 25 separate from the computing system 12. For example, the virtual equipment handler 22 may allocate the network node 25 for the vCPE 24, and then configure and manage the vCPE 24 while executed on the network node 25.

The computing environment 10 can include a first computing device 26. The first computing device 26 can be any type or manner of computing device, such as a user device (e.g., a smartphone, laptop, desktop computer, wearable device, Mixed Reality (MR) device, etc.), a network device, an Internet-of-Things (IoT) device, a virtualized entity (e.g., a virtualized hardware device, a model server that serves a machine-learned model instance, etc.). The first computing device 26 can be associated with a particular entity, such as a user of an organization that implements the computing environment 10. For example, if the computing environment 10 was implemented by an internet service provider, the first computing device 26 may be a user device associated with a user that subscribes to internet services provided by the internet service provider.

The first computing device 26 can send a first network access request 28 to the vCPE 24 (or the computing system 12, generally). The first network access request 28 can include a request to join a wireless network implemented by the computing system 12. In addition, the first network access request 28 can include a pre-shared key 30 that associates the first computing device 26 with the vCPE 24. As described herein, the pre-shared key 30 can “associate” the vCPE 24 to the first computing device 26 by identifying the first computing device 26 itself, and/or by identifying an entity associated with the first computing device 26. For example, the pre-shared key 30 may be a key that uniquely identifies the first computing device 26 as being associated with (i.e., assigned to) the vCPE 24. If the user owned another computing device (e.g., a smartphone), the other device may be assigned a different pre-shared key that associates the other device with the same vCPE 24. For another example, the pre-shared key may be a key that uniquely identifies an entity associated with the first computing device 26. If the user owned another computing device, that computing device may send the same pre-shared key 30 associated with the vCPE 24.

The identifier 20 can evaluate the pre-shared key 30 to identify the vCPE 24 associated with the pre-shared key 30. For example, the identifier 20 can include device identification information 31. The device identification information 31 can associate pre-shared key(s) with specific vCPE(s). In some implementations, the device identification information 31 can associate the vCPE 24 with a plurality of different pre-shared keys. For example, the pre-shared key 30 may be one of a number of pre-shared keys granted to the user for a corresponding number of user devices. In some implementations, the pre-shared key 30 can uniquely identify both the first computing device 26 and the entity to which the first computing device 26 belongs. For example, if the first computing device 26 is owned by (or associated with) a particular user, the pre-shared key 30 may uniquely identify both the first computing device 26 and the user.

The first computing device 26 can be connected to a first access point 32. More specifically, a first access point 32 can generate a wireless signal 34 at a first location 36. For example, the first access point 32 may generate the wireless signal 34 from the first floor of a Multi Unit Dwelling (MDU) (e.g., an apartment building, townhome, condominium complex, etc.). The wireless signal 34 may be receivable within a certain radius of the first access point 32.

The first access point 32 can be any type or manner of wireless device that generates a Wifi signal or the like. Specifically, in some implementations, the first access point 32 can be a wireless mesh extender or a wireless router operating in a modified capacity. As described herein, a wireless router operating in a “modified capacity” refers to a router in which some (or all) of the layer 3 network functions typically provided by the router have been moved to a vCPE (e.g., the vCPE 24). Additionally, in some implementations, a wireless router operating in a modified capacity can be modified to implement functions to facilitate secure communication between the router and the vCPE that implements the layer 3 functions typically provided by the router. For example, the first access point 32 can be a router modified with a network bridge that bridges a Wifi interface and LAN interface of the router to a tunnel interface (not illustrated) for a layer 2 tunnel 38-1.

The layer 2 tunnel 38-1 (i.e., a transparent overlay) can be a logical link that maintains a layer 2 adjacency (i.e., a direct connection via the data link layer) between the vCPE and the first access point 32. The layer 2 tunnel 38-1 can include any number of different communication protocols depending on the back-haul use case and specific implementation of the network. In some implementations, the layer 2 tunnel 38-1 can be an Ethernet segment between the first access point 32 and the vCPE 24 where a 1:1 VLAN access and backhaul architecture is in place. If the first access point 32 is a legacy Wi-Fi gateway, this setup can enable the re-use of the legacy Wi-Fi gateway by placing it into bridge mode. Alternatively, in some implementations, the layer 2 tunnel 38-1 can be a layer 2 over IP tunnel such as Ethernet over Generic Routing Encapsulation (EoGRE) between the vCPE and the first access point 32. The layer 2 over IP tunnel can be used to establish a layer 2 adjacency between the first computing device 26 and a virtual gateway function (e.g., a layer 3 gateway) hosted by the vCPE 24.

In some implementations, the vCPE 24 can include a plurality of virtual Network Functions (vNFs) 40-1-40-N (generally, vNFs 40). The vNFs 40 can include vNFs that perform functions (e.g., layer 3 functions) conventionally performed at a physical access point device. For example, in some implementations, the vNFs 40 can include a gateway vNF 40-1. The gateway vNF 40-1 can include an address assigner 42. In response to the first network access request 28, the address assigner 42 can assign an internal IP address to the first computing device 26 if an address has not already been assigned to the first computing device 26. In some implementations, the address assigner 42 can assign an external (i.e., public) IP address to the first computing device 26. For example, the address assigner 42 may maintain an external IP address for the vCPE 24, and may assign a specific port number to the first computing device 26.

In some implementations, the gateway vNF 40-1 includes a layer 3 endpoint 44. The layer 3 endpoint 44 can act as an endpoint for the layer 2 tunnel 38-1 between the vCPE 24 and the first access point 32. For example, the first access point 32 can include a layer 3 encapsulator 46. The layer 3 encapsulator 46 can encapsulate packets for layer 3 transport over the layer 2 tunnel 38-1 to the layer 3 endpoint 44. The layer 3 endpoint 44 can de-encapsulate the encapsulated packets for transport over a carrier-grade NAS.

In some implementations, the first access point 32 can include a learning bridge 48. The learning bridge 48 can be a learning bridge as defined by conventional wireless standards (e.g., Institute of Electrical and Electronics Engineers (IEEE) 802.1D and 802.1Q standards), meaning all local traffic stays local, and the first access point 32 does not forward local traffic over the layer 2 tunnel 38-1 unless explicitly configured to do so. In some implementations, the learning bridge 48 can be activated when the first access point 32 is placed in a “bridge mode,” which is a mode where the first access point 32 acts as a bridge to a virtual device that implements layer 3 functions that would otherwise be implemented by the first access point 32.

As described previously, at the time T1, the first computing device 26 can transmit the first network access request 28 via the first access point 32 to the computing system 12. The vCPE 24 can assign an address to the first computing device 26 with the address assigner 42. The vCPE 24 can also perform any other session establishment operations necessary to establish a connection with the first computing device 26. Next, at the time T1, a second computing device 50 (e.g., a smartphone, laptop, virtualized device, etc.) can transmit a communication session request 52 to the computing system 12. The communication session request 52 can be addressed to the IP address assigned to the first computing device 26 by the gateway vNF 40-1. For example, the communication session request 52 may include an external IP address 54 that was assigned to the first computing device by the gateway vNF 40-1.

Based on the external IP address 54, the vCPE 24 can route the communication session request 52 to the first computing device 26 via the layer 2 tunnel. More specifically, at the first time T1, the vCPE 24 can establish a live communication session 56 between the first computing device 26 and the second computing device 50. In some implementations, the live communication session 56 can be an audioconference, videoconference, multimedia conference, etc. in which multiple participants exchange communication information. Additionally, or alternatively, in some implementations, the live communication session 56 can be a real-time multiplayer videogame session. Additionally, or alternatively, in some implementations, the live communication session 56 can be a content streaming session (e.g., in which the second computing device 50 streams media content to the first computing device 26 in real-time).

In some implementations, to establish the live communication session 56, the vCPE 24 can transmit communication session establishment information 58 to the first computing device 26 via the layer 2 tunnel to the first access point 32. The communication session establishment information 58 can include an IP address for the second computing device, configuration information for a communication session, etc. The vCPE 24 can then establish the live communication session 58 at the first time T1 between the second computing device and the first computing device 26.

Turning to FIG. 1B, FIG. 1B illustrates the computing environment 10 of FIG. 1A at a second time T2 subsequent to the first time T1 according to some implementations of the present disclosure. FIG. 1B will be discussed in conjunction with FIG. 1A. In particular, at a second time T2, the first computing device 26 may be physically relocated from the first location 36 to a second location 60. For example, the first computing device 26 may be a user computing device held by a user that is traversing from the first location 36 to the second location 60.

While traversing, the first computing device 26 can exit the coverage area of the wireless signal 34 generated by the first access point 32 and enter a coverage area of a wireless signal 62 generated by a second access point 64 located at the second location 60. However, this transition between coverage areas of the wireless signals 34 and 62 can occur while the live communication session 56 occurs between the first computing device 26 and the second computing device 50.

Conventionally, when the first computing device 26 transitions to the wireless signal 62 generated by the second access point 64, the second access point 64 will assign a new IP address to the second computing device 50, and the live communication session 56, which was maintained based on the IP address previously assigned to the first computing device 26, will be dropped. However, implementations of the present disclosure can include a vCPE with a session maintainer 66. For example, the session maintainer 66 can be included in the gateway vNF 40-1 of the vCPE. The session maintainer 66 can maintain the live communication session 56 while the first computing device 26 transitions from the first access point 32 to the second access point 64.

To do so, the vCPE 24 can first receive a second network access request 68 from the first computing device 26 via the second access point 64. The second network access request 68 can include the pre-shared key 30. The pre-shared key 30 can be the same pre-shared key 30 as was included in the first network access request 28. In some implementations, the second network access request 68 may be received via a layer 2 tunnel 38-2. In some implementations, the layer 2 tunnel 38-2 can be a different tunnel than the layer 2 tunnel 38-1. For example, the vCPE 24 may maintain a plurality of layer 2 tunnels 38-1-38-N (generally, layer 2 tunnels 38) between a corresponding plurality of access points. Alternatively, in some implementations, the layer 2 tunnel 38-2 can be the “same” layer 2 tunnel (e.g., with the same configuration, etc.) as the layer 2 tunnel 38-1.

Based on the pre-shared key 30, the session maintainer 66 can determine that the first computing device 26 has already been assigned an IP address by the gateway vNF 40-1 while connected to the first access point 32. For example, the session maintainer 66 may store and/or access routing information 69. The routing information 69 can store previously assigned external IP addresses and associate the IP addresses with particular pre-shared keys. To follow the example illustrated in FIG. 1A, the routing information 69 can associate the pre-shared key 30 (e.g., PSK 23094823) with the external IP address 73.45.112.219 and the port 50550.

The session maintainer 66 can re-assign (or can otherwise maintain assignment of) the external IP address 54 to the first computing device 26. As such, traffic from the live communication session 56 that is addressed to the external IP address 54 will continue to be delivered to the first computing device 26 without any disruption in the live communication session 56. In some implementations, to do so, the session maintainer 66 can transmit communication session maintenance information 70 to the first computing device 26. The communication session maintenance information 70 can include information necessary for the first computing device 26 to maintain the live communication session 56 with the second computing device 50, such as an external IP address for the second computing device 50, a configuration for the live communication session 56, etc.

Turning to FIG. 1C, FIG. 1C illustrates the computing environment 10 of FIG. 1A at a third time T3 according to some implementations of the present disclosure. FIG. 1C will be discussed in conjunction with FIGS. 1A and 1B. In some implementations, the time T3 can refer to a time period that runs at least partially concurrent with the time T2. Alternatively, in some implementations, the time T3 can refer to a time subsequent to the time T2. At the time T3, a third computing device 72 can be connected to the vCPE 24 via a third access point 74 generating a wireless signal 76. The third access point can be an access point located at a third location 78. For example, the first location 36 and the second location 60 may be the pool area and the exercise facilities of an MDU, respectively, while the third location 78 is the location of the user's dwelling in the MDU (e.g., the user's room, a hallway outside the user's room, etc.). The third computing device 72 can be a device belonging to the same user as the first computing device 26. For example, the third computing device 72 may be a media server, and the first computing device 26 may be a laptop.

The third computing device 72 can transmit local information 80 over a LAN to the first computing device 26. More specifically, the vCPE 24 can include a virtualized LAN (vLAN) vNF 40-2. The vLAN vNF 40-2 can implement one or more vLAN instances 82-1-82-N. Each of the vLAN instances can be logical networks that logically group devices on a per-network basis. If a device is assigned to one of the vLAN instances 82, the device can detect other devices assigned to the same vLAN instances, but cannot detect devices assigned to other vLAN instances. For example, if the third computing device 72 and the first computing device 26 are assigned to the vLAN instance 82-1, the third computing device 72 can “see” the first computing device 26 on the network.

The third computing device 72 can transmit the local information 80 over a layer 2 tunnel 38-3 between the third access point 74 and the computing system 12. The local information 80 can include an internal IP address 83 assigned to the first computing device 26 at the first time T1 by the address assigner 42. The local information 80 can further include a second pre-shared key 84 that associates the third computing device 72 with the vCPE 24. For example, assume the vCPE 24 is a vCPE instantiated specifically for a user that owns both the first computing device 26 and the third computing device 72. The pre-shared key 30 and the second pre-shared key 84 can be shared with the first computing device 26 and the third computing device 72, respectively, when the devices are initially registered. As such, even though the second pre-shared key 84 is different than the pre-shared key 30, the second pre-shared key can associate the third computing device 72 with the same vCPE 24 as the pre-shared key 30.

To follow the illustrated example, the device identification information 31 can associate the pre-shared key 84 (e.g., PSK “89045690”) included in the local information 80 with the vCPE 24 (e.g., vCPE_331). The device identification information 31 can also associate the pre-shared key 30 (e.g., PSK “23094823”) with the same vCPE 24 (e.g., vCPE_331). As such, the first computing device 26 and the third computing device 72 can likely be owned by the same user or organization, and can be assigned to the same vLAN instance 82-1.

The vLAN vNF 40-2 can include an information labeler 86 that labels the local information 80 as “layer 2” information destined for the first computing device 26. The information labeler 86 can act in conjunction with the identifier 20 to route the local information 80 to the first computing device 26. For example, the vLAN vNF 40-2 can receive the local information 80 via the layer 2 tunnel 38-3 between the vCPE 24 and the third computing device 72. The vLAN vNF 40-2 can then forward the local information 80 to the first computing device 26 via the layer 2 tunnel 38-2. In such fashion, implementations described herein can maintain virtualized LAN connectivity between devices during access point transition.

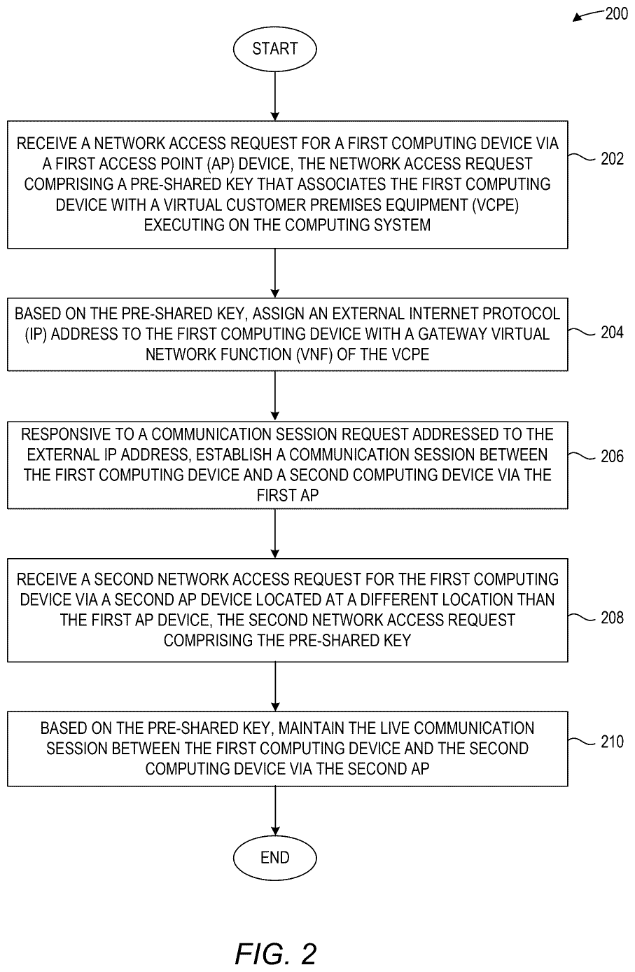

FIG. 2 depicts a flow chart diagram of an example method 200 for seamless communication session continuity during access point transition according to some implementations of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

At 202, a computing system can receive a network access request for a first computing device via a first Access Point (AP) device, the network access request comprising a pre-shared key that associates the first computing device with a vCPE executing on the computing system. In some implementations, the vCPE is instantiated in response to the network access request.

In some implementations, receiving the network access request for the first computing device via the first AP can include receiving the network access request via a virtual point-to-point tunnel established between the first AP and the computing system. In some implementations, the virtual point-to-point tunnel comprises an Ethernet over Generic Routing Encapsulation (EoGRE) tunnel.

At 204, the computing system (or the vCPE executed on the computing system) can, based on the pre-shared key, assign an external Internet Protocol (IP) address to the first computing device with a gateway vNF of the vCPE. In some implementations, the vCPE comprises a plurality of vNFs comprising the gateway vNF.

In some implementations, prior to assigning the external IP address to the first computing device with the gateway vNF of the vCPE associated with the pre-shared key, the computing system can instantiate the vCPE for a user associated with the first computing device.

In some implementations, to assign the external IP address to the first computing device, the computing system can assign an internal IP address to the first computing device with the gateway vNF of the vCPE associated with the pre-shared key. The computing system can receive first information from a third computing device via a third access point, wherein the first information is addressed to the internal IP address. The computing system can send the first information to the first computing device via the first AP.

At 206, the computing system (or the vCPE executed on the computing system) can, responsive to a communication session request addressed to the external IP address, establish a communication session between the first computing device and a second computing device via the first AP.

At 208, the computing system (or the vCPE executed on the computing system) can receive a second network access request for the first computing device via a second AP located at a different location than the first AP, the second network access request comprising the pre-shared key.

At 210, the computing system (or the vCPE executed on the computing system) can, based on the pre-shared key, maintain the live communication session between the first computing device and the second computing device via the second AP.

In some implementations, the computing system can receive second information from the third computing device via the third access point, wherein the first information is addressed to the internal IP address. The computing system can send the second information to the first computing device via the second AP. In some implementations, the plurality of vNFs comprises a vLAN vNF that maintains a plurality of vLANs, wherein a first vLAN of the plurality of vLANs comprises a plurality of internal IP addresses comprising the internal IP address. To send the first information to the first computing device via the first AP, the computing system can identify, with the vLAN vNF, the first information as local traffic addressed to some device connected to one of the plurality of vLANs. The computing system can route the first information to the first computing device over the first vLAN of the plurality of vLANs via the first AP.

In some implementations, the plurality of vNFs further comprises a virtual firewall function.

In some implementations, to send the second information to the first computing device via the second AP, the computing system can identify, with the vLAN vNF, the second information as local traffic addressed to some device connected to one of the plurality of vLANs. The computing system can route the second information to the first computing device over the first vLAN of the plurality of vLANs via the second AP.

In some implementations, to assign the internal IP address to the first computing device with the gateway vNF of the vCPE associated with the pre-shared key, the computing system can establish, using the vLAN vNF, a connection between the first vLAN and the first computing device, wherein the connection is addressed with the internal IP address. To maintain the communication session between the first computing device and the second computing device via the second AP, the computing system can maintain, using the vLAN vNF, the connection between the vLAN and the first computing device via the second AP.

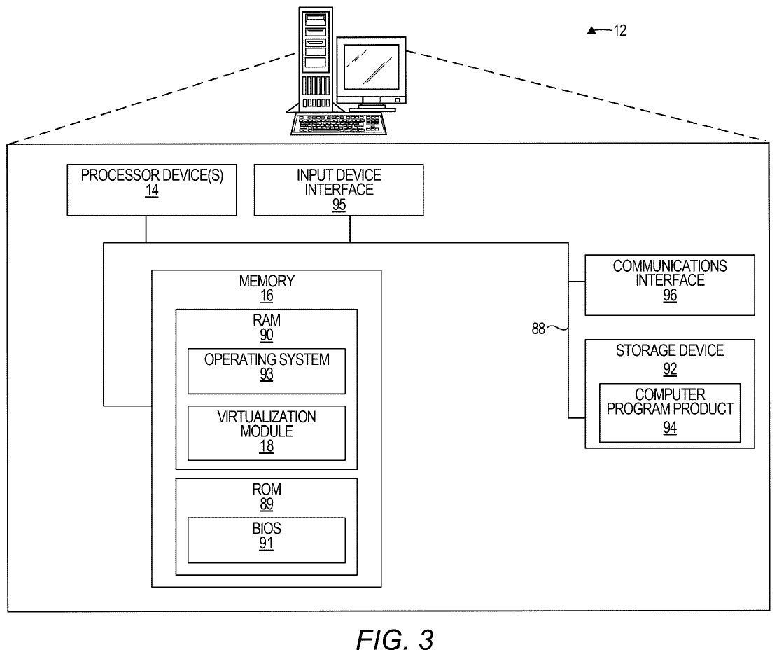

FIG. 3 is a block diagram of the computing system 12 suitable for implementing examples according to one example. The computing system 12 may comprise any computing or electronic device capable of including firmware, hardware, and/or executing software instructions to implement the functionality described herein, such as a computer server, a desktop computing device, a laptop computing device, a smartphone, a computing tablet, or the like. The computing system 12 includes the processor device(s) 14, the memory 16, and a system bus 88. The system bus 88 provides an interface for system components including, but not limited to, the memory 16 and the processor device(s) 14. The processor device(s) 14 can be any commercially available or proprietary processor.

The system bus 88 may be any of several types of bus structures that may further interconnect to a memory bus (with or without a memory controller), a peripheral bus, and/or a local bus using any of a variety of commercially available bus architectures. The memory 16 may include non-volatile memory 89 (e.g., read-only memory (ROM), erasable programmable read-only memory (EPROM), electrically erasable programmable read-only memory (EEPROM), etc.), and volatile memory 90 (e.g., random-access memory (RAM)). A basic input/output system (BIOS) 91 may be stored in the non-volatile memory 89 and can include the basic routines that help to transfer information between elements within the computing system 12. The volatile memory 90 may also include a high-speed RAM, such as static RAM, for caching data.

The computing system 12 may further include or be coupled to a non-transitory computer-readable storage medium such as a storage device 92, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 92 and other drives associated with computer-readable media and computer-usable media may provide non-volatile storage of data, data structures, computer-executable instructions, and the like.

A number of modules can be stored in the storage device 92 and in the volatile memory 90, including an operating system 93 and one or more program modules, such as the virtualization module 18, which may implement the functionality described herein in whole or in part. All or a portion of the examples may be implemented as a computer program product 94 stored on a transitory or non-transitory computer-usable or computer-readable storage medium, such as the storage device 92, which includes complex programming instructions, such as complex computer-readable program code, to cause the processor device(s) 14 to carry out the steps described herein. Thus, the computer-readable program code can comprise software instructions for implementing the functionality of the examples described herein when executed on the processor device(s) 14. The processor device(s) 14, in conjunction with the virtualization module 18 in the volatile memory 90, may serve as a controller, or control system, for the computing system 12 that is to implement the functionality described herein.

Because the virtualization module 18 is a component of the computing system 12, functionality implemented by the virtualization module 18 may be attributed to the computing system 12 generally. Moreover, in examples where the virtualization module 18 comprises software instructions that program the processor device(s) 14 to carry out functionality discussed herein, functionality implemented by the virtualization module 18 may be attributed herein to the processor device(s) 14.

An operator, such as the user, may also be able to enter one or more configuration commands through a keyboard (not illustrated), a pointing device such as a mouse (not illustrated), or a touch-sensitive surface such as a display device. Such input devices may be connected to the processor device(s) 14 through an input device interface 95 that is coupled to the system bus 88 but can be connected by other interfaces such as a parallel port, an Institute of Electrical and Electronic Engineers (IEEE) 1394 serial port, a Universal Serial Bus (USB) port, an IR interface, and the like. The computing system 12 may also include a communications interface 96, such as an Ethernet transceiver and/or a Wi-Fi transceiver, or the like, suitable for communicating with the network as appropriate or desired. The computing system 12 may also include a video port configured to interface with a display device, to provide information to the user.

Individuals will recognize improvements and modifications to the preferred examples of the disclosure. All such improvements and modifications are considered within the scope of the concepts disclosed herein and the claims that follow.

What is claimed is:

1. A method comprising:
receiving, by a computing system comprising one or more processor devices, a network access request for a first computing device via a first Access Point (AP), the network access request comprising a pre-shared key that associates the first computing device with a virtual Customer Premises Equipment (vCPE) executing on the computing system;
based on the pre-shared key, assigning, by the vCPE, an external Internet Protocol (IP) address to the first computing device with a gateway virtual Network Function (vNF) of the vCPE;
responsive to a communication session request addressed to the external IP address, establishing, by the vCPE, a live communication session between the first computing device and a second computing device via the first AP;
receiving, by the vCPE, a second network access request for the first computing device via a second AP located at a different location than the first AP, the second network access request comprising the pre-shared key; and
based on the pre-shared key, maintaining, by the vCPE, the live communication session between the first computing device and the second computing device via the second AP.

2. The method of claim 1, wherein, prior to assigning the external IP address to the first computing device with the gateway vNF of the vCPE associated with the pre-shared key, the method comprises:
instantiating the vCPE for a user associated with the first computing device.

3. The method of claim 2, wherein the vCPE is instantiated in response to the network access request.

4. The method of claim 1, wherein the vCPE comprises a plurality of vNFs comprising the gateway vNF.

5. The method of claim 4, wherein assigning the external IP address to the first computing device further comprises:
assigning, by the computing system, an internal IP address to the first computing device with the gateway vNF of the vCPE associated with the pre-shared key;
receiving, by the computing system, first information from a third computing device via a third access point, wherein the first information is addressed to the internal IP address; and
sending, by the computing system, the first information to the first computing device via the first AP.

6. The method of claim 5, wherein the method further comprises:
receiving, by the computing system, second information from the third computing device via the third access point, wherein the first information is addressed to the internal IP address; and
sending, by the computing system, the second information to the first computing device via the second AP.

7. The method of claim 6, wherein the plurality of vNFs comprises a virtual Local Area Network (vLAN) vNF that maintains a plurality of vLANs, wherein a first vLAN of the plurality of vLANs comprises a plurality of internal IP addresses comprising the internal IP address; and
wherein sending the first information to the first computing device via the first AP comprises:
identifying, by the computing system with the vLAN vNF, the first information as local traffic addressed to some device connected to one of the plurality of vLANs; and
routing, by the computing system, the first information to the first computing device over the first vLAN of the plurality of vLANs via the first AP.

8. The method of claim 7, wherein sending the second information to the first computing device via the second AP comprises:
identifying, by the computing system with the vLAN vNF, the second information as local traffic addressed to some device connected to one of the plurality of vLANs; and
routing, by the computing system, the second information to the first computing device over the first vLAN of the plurality of vLANs via the second AP.

9. The method of claim 8, wherein assigning the internal IP address to the first computing device with the gateway vNF of the vCPE associated with the pre-shared key comprises:
establishing, by the computing system using the vLAN vNF, a connection between the first vLAN and the first computing device, wherein the connection is addressed with the internal IP address; and
wherein maintaining the live communication session between the first computing device and the second computing device via the second AP further comprises:
maintaining, by the computing system using the vLAN vNF, the connection between the vLAN and the first computing device via the second AP.

10. The method of claim 4, wherein the plurality of vNFs further comprises a virtual firewall function.

11. The method of claim 1, wherein receiving the network access request for the first computing device via the first AP comprises:
receiving, by the computing system, the network access request via a virtual point-to-point tunnel established between the first AP and the computing system.

12. The method of claim 11, wherein the virtual point-to-point tunnel comprises an Ethernet over Generic Routing Encapsulation (EoGRE) tunnel.

13. A computing system comprising:
one or more processor devices to:
receive a network access request for a first computing device via a first Access Point (AP) device, the network access request comprising a pre-shared key that associates the first computing device with a virtual Customer Premises Equipment (vCPE) executing on the computing system;
based on the pre-shared key, assign an external Internet Protocol (IP) address to the first computing device with a gateway virtual Network Function (vNF) of the vCPE;
responsive to a communication session request addressed to the external IP address, establish a live communication session between the first computing device and a second computing device via the first AP;
receive a second network access request for the first computing device via a second AP located at a different location than the first AP, the second network access request comprising the pre-shared key; and
based on the pre-shared key, maintain the live communication session between the first computing device and the second computing device via the second AP.

14. The computing system of claim 13, wherein, prior to assigning the external IP address to the first computing device with the gateway vNF of the vCPE associated with the pre-shared key, the one or more processor devices are to:
instantiate the vCPE for a user associated with the first computing device.

15. The computing system of claim 14, wherein the vCPE is instantiated in response to the network access request.

16. The computing system of claim 13, wherein the vCPE comprises a plurality of vNFs comprising the gateway vNF.

17. The computing system of claim 16, wherein, to assign the external IP address to the first computing device, the one or more processor devices are further to:
assign an internal IP address to the first computing device with the gateway vNF of the vCPE associated with the pre-shared key;
receive first information from a third computing device via a third access point, wherein the first information is addressed to the internal IP address; and
send the first information to the first computing device via the first AP.

18. The computing system of claim 17, wherein the one or more processor devices are further to:
receive second information from the third computing device via the third access point, wherein the first information is addressed to the internal IP address; and
send the second information to the first computing device via the second AP.

19. The computing system of claim 18, wherein the plurality of vNFs comprises a virtual vLAN vNF that maintains a plurality of vLANs, wherein a first vLAN of the plurality of vLANs comprises a plurality of internal IP addresses comprising the internal IP address; and
wherein, to send the first information to the first computing device via the first AP, the one or more processor devices are to:
identify, with the vLAN vNF, the first information as local traffic addressed to some device connected to one of the plurality of vLANs; and
route the first information to the first computing device over the first vLAN of the plurality of vLANs via the first AP.

20. A non-transitory computer-readable storage medium that includes executable instructions configured to cause a processor device executing a virtual Customer Premises Equipment (vCPE) to:
receive a network access request for a first computing device via a first Access Point (AP) device, the network access request comprising a pre-shared key that associates the first computing device with the vCPE;
based on the pre-shared key, assign an external Internet Protocol (IP) address to the first computing device with a gateway virtual Network Function (vNF) of the vCPE;
responsive to a communication session request addressed to the external IP address, establish a live communication session between the first computing device and a second computing device via the first AP;
receive a second network access request for the first computing device via a second AP located at a different location than the first AP, the second network access request comprising the pre-shared key; and
based on the pre-shared key, maintain the live communication session between the first computing device and the second computing device via the second AP.
